(19) United States
(12) Patent Application Publication
(10) Pub. No.: US 2024/0270929 A1
(43) Pub. Date: Aug. 15, 2024

(54) CAPILLARY UNDERFILL FORMULATIONS THAT INCLUDE CARBON NANOTUBES, CONTAINERS, AND METHODS

(71) Applicant: Intel Corporation, Santa Clara, CA (US)

(72) Inventors: Clay Arrington, Queen Creek, AZ (US); Kyle Arrington, Gilbert, AZ (US); Ziyin Lin, Chandler, AZ (US); Jose Waimin, Gilbert, AZ (US); Dingying Xu, Chandler, AZ (US)

(21) Appl. No.: 18/166,005

(22) Filed: Feb. 8, 2023

(51) Int. Cl. C08K 3/04; B82Y 30/00; B82Y 40/00; C08K 9/04

(52) U.S. Cl. CPC C08K 3/041; B82Y 30/00; B82Y 40/00; C08K 9/04; C08K 2003/023; C08K 2201/011

(57) ABSTRACT

Capillary underfill formulations that may include fillers. The fillers may include carbon nanotubes, such as surface functionalized carbon nanotubes. Methods for forming capillary underfill materials that may have improved fracture toughness, reduced crack propagation, and a reduced likelihood of delamination. The surface functionalized carbon nanotubes may include amine functionalized carbon nanotubes. Containers, such as syringes, that may have a reservoir in which a capillary underfill formulation is disposed.

### TECHNICAL FIELD

This disclosure generally relates to carbon nanotube-containing fillers for capillary underfill (CUF) materials, and, more particularly, to CUF formulations that include surface functionalized carbon nanotubes.

### BACKGROUND

After heating and cooling cycles, warpage commonly leads to delamination and cracking between CUF materials and adjacent interfaces, such as molding compounds and solder. This degradation mechanism is likely due to the coefficient of thermal extension (CTE) mismatch and/or stress buildup of the material, wherein the material toughness is unable to compensate for these stress conditions.

Most, if not all, CUF materials have a relatively low thermal conductivity. Commonly used fillers are thermal insulators, and this feature is typically overlooked, because these materials are chosen based solely for their CTE.

For example, silica particles have been used as fillers for CUF materials in an attempt to improve composite epoxy network modulus and decrease the CTE. Silica particles, however, have demonstrated a limited ability to bridge cracks and/or prevent or reduce crack propagation during stress buildup. Silica filled composites also typically exhibit reduced adhesive strength to various surfaces, and afford little, if any, increase in the thermal conductivity of the composites.

There remains a need for CUF formulations and materials that include improved fillers, such as fillers that (i) reduce or eliminate delamination and/or cracking between CUF materials and adjacent interfaces, and/or (ii) improve crack resistance, adhesion, and/or thermal conductivity of CUF materials.

### BRIEF DESCRIPTION OF THE DRAWINGS

FIG. 1 depicts an embodiment of a container, and an embodiment of a CUF formulation disposed in the container.

FIG. 2 depicts a schematic of an embodiment of a method provided herein, as well as an embodiment of a container, and an embodiment of an apparatus.

FIG. 3 depicts an embodiment of a comparative CUF material.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, process, algorithm, and other changes. Portions and features of some embodiments may be included in, or substituted for, those of other embodiments. Embodiments set forth in the claims encompass all available equivalents of those claims.

Provided herein are fillers, such as fillers for CUF materials, that may improve or eliminate the weak adhesion and/or cohesive properties of current CUF materials. In some embodiments, the fillers, CUF formulations, and CUF materials provided herein may include carbon nanotubes, such as surface functionalized carbon nanotubes, that may have improved dispersion and/or adhesion to matrix materials, such as epoxy materials, thereby providing, in some embodiments, increased fracture resistance at low filler volume. The carbon nanotubes herein may be combined with silica fillers, thereby forming composites that may have enhanced reliability and/or thermal conductivity.

### CUF Formulations

Provided herein are embodiments of CUF formulations, which may include a matrix material precursor; and a filler dispersed in the matrix material precursor, wherein the filler may include a plurality of carbon nanotubes, such as surface functionalized carbon nanotubes. The filler may be evenly or unevenly dispersed in the matrix material precursor.

The matrix material precursor may include any of those known in the art. The matrix material precursor may include a polymer precursor. The matrix material precursor may include an epoxy resin precursor. The matrix material precursor, prior to curing, may have a viscosity that facilitates the methods provided herein, which may include forming a capillary flow of the CUF formulations.

### Carbon Nanotubes

Generally, carbon nanotubes may be present at any effective concentration in the CUF formulations provided herein. In some embodiments, a plurality of carbon nanotubes, such as a plurality of surface functionalized carbon nanotubes, may be present in a CUF formulation at a concentration of about 0.1% to about 10%, 0.1% to about 8%, 0.1% to about 6%, 0.1% to about 4%, 0.1% to about 2%, about 0.5% to about 1.5%, less than 5%, less than 4%, less than 3%, less than 2%, or less than 1%, by weight, based on the weight of the CUF formulation.

The carbon nanotubes provided herein may be added to other components of a CUF formulation in any manner and in any order. For example, a plurality of carbon nanotubes may be added to a matrix material precursor before, during, and/or after silica particles are added to the matrix material precursor. During and/or after the addition of a plurality of carbon nanotubes to a matrix material precursor, the matrix material precursor may be agitated (e.g., stirred), sonicated, or a combination thereof.

The carbon nanotubes may include pristine carbon nanotubes, surface functionalized carbon nanotubes, or a combination thereof. The surface functionalized carbon nanotubes may include carbon nanotubes substituted with a moiety that includes a nucleophilic group or an electrophilic group. The nucleophilic group and/or the electrophilic group may be compatible with and/or may chemically react with the matrix material precursor before and/or after curing.

The nucleophilic group generally may include any known nucleophile, such as a functional group featuring an atom having a lone pair of electrons (e.g., an amine, a hydroxy, etc.).

The nucleophilic group may include an amine. Therefore, a plurality of surface functionalized carbon nanotubes may include amine functionalized carbon nanotubes. In some embodiments, the amine functionalized carbon nanotubes may be substituted with a moiety of the following formula:

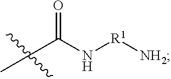

wherein R¹ may be a divalent C₁-C₁₀ hydrocarbyl. In some embodiments, R¹ may be a linear divalent C₁-C₁₀ hydrocarbyl. In some embodiments, R¹ may be a branched divalent C₁-C₁₀ hydrocarbyl. Not wishing to be bound by any particular theory, it is believed that the character of the divalent C₁-C₁₀ hydrocarbyl may impart, via varying degrees of steric effects, one or more desirable features to the formulations and/or fillers provided herein, such as, for example, reduced or eliminated agglomeration of carbon nanotubes. Although a terminal primary amine is depicted in the foregoing formula, an amine of an amine functionalized carbon nanotubes may include, additionally or alternatively, a secondary amine and/or a tertiary amine.

The electrophilic group generally may include any known electrophile, such as a functional group that features an electron poor atom (e.g., an atom covalently bonded to a more electronegative atom). In some embodiments, the electrophilic group may include an anhydride, an alkyl halide, a peracid, etc.

Not wishing to be bound by any particular theory, it is believed that improved adhesion to a matrix material and/or carbon nanotube dispersion may be achieved or improved through surface functionalization of the carbon nanotubes. Surface treatments, such as those provided herein (e.g., amine functionalization), may (i) increase the adhesion between carbon nanotubes and a matrix, such as an epoxy matrix, as measured by pull-out energy, (ii) reduce agglomeration, which may be measured as a reduction in interaction energy, and/or (iii) enhance mechanical properties, such as Young's modulus.

The carbon nanotubes of the CUF formulations provided herein may have any average length. In some embodiments, a plurality of carbon nanotubes, such as a plurality of surface functionalized carbon nanotubes, may have an average length of about 5 nm to 50 nm, about 10 nm to about 50 nm, about 20 nm to about 50 nm, about 25 nm to about 50 nm, about 30 nm to about 50 nm, about 35 nm to about 50 nm, or about 40 nm to about 50 nm.

The carbon nanotubes of the CUF formulations provided herein may have any aspect ratio. In some embodiments, the plurality of surface functionalized carbon nanotubes may have an average aspect ratio of about 100:1 to about 100,000:1, about 1,000:1 to about 100,000:1, about 10,000:1 to about 100,000:1, about 20,000:1 to about 100,000:1, about 30,000:1 to about 100,000:1, about 40,000:1 to about 100,000:1, about 50,000:1 to about 100,000:1, about 100:1 to about 50,000:1, about 100:1 to about 40,000:1, about 100:1 to about 30,000:1, about 100:1 to about 20,000:1, about 100:1 to about 10,000:1, about 100:1 to about 1,000:1, or about 100:1 to about 500:1.

Not wishing to be bound by any particular theory, it is believed that selecting a carbon nanotube aspect ratio may allow for bias in through plane and in plane transport properties. Relatively longer carbon nanotubes may display more anisotropic transport and mechanical phenomena than relatively shorter carbon nanotubes. This tunability may allow for modulation in mechanical and thermal properties, depending upon package design and requirements. Relatively longer carbon nanotubes may allow for higher elongation, higher thermal conductivities, and lower modulus, while relatively shorter carbon nanotubes may trend oppositely at a maintained concentration.

The carbon nanotubes of the CUF formulations provided herein may include single-walled carbon nanotubes, multi-walled carbon nanotubes, or a combination thereof.

Not wishing to be bound by any particular theory, it is believed that the carbon nanotubes, such as surface functionalized carbon nanotubes, provided herein may, at least in some embodiments, (i) provide reduced crack propagation due, at least in part, to their advantageous aspect ratio, and (ii) improve resin adhesion relative to other commonly used fillers, such as native silica fillers. The aspect ratio of the carbon nanotubes may allow, at least in some embodiments, for improved capillary flow via the at least partial alignment of high aspect ratio fillers when under capillary stress reducing viscosity. Moreover, the inclusion of carbon nanotubes, such as surface functionalized carbon nanotubes, may increase the thermal conductivities of the CUF formulations provided herein, which may allow for better thermal transport through chip gaps. The designer, e.g., highly-tunable, nature of carbon nanotubes may allow for the tuning of properties through multiple variables, such as the size (e.g., aspect ratio) of the carbon nanotubes, surface chemistry, architecture (e.g., single-walled and/or multi-walled), etc. Surface functionalization may provide resistance to, or the prevention of, carbon nanotube aggregation, which, may reduce the risk of filler rich areas, which are commonly observed in many silica filled epoxy composites.

### Silica Particles

In some embodiments, the fillers provided herein may include silica particles. The silica particles may include any of those known in the art, such as those used in commercially available fillers, such as commercially available fillers for CUF materials. Therefore, the CUF formulations provided herein may include commercially available CUF materials to which a plurality of carbon nanotubes has been added.

Silica particles may be present in a CUF formulation at any effective concentration. In some embodiments, the silica particles may be present in a CUF formulation at a concentration of about 0.1% to about 10%, 0.1% to about 8%, 0.1% to about 6%, 0.1% to about 4%, 0.1% to about 2%, about 0.5% to about 1.5%, less than 5%, less than 4%, less than 3%, less than 2%, or less than 1%, by weight, based on the weight of the formulation.

### Containers

Also provided herein are containers. The containers may include a reservoir in which any of the CUF formulations provided herein are disposed. The container, which may include a syringe, may permit its contents to be stored in a number of conditions, such as temperatures below the freezing point of a matrix material precursor. The container also may include a nozzle.

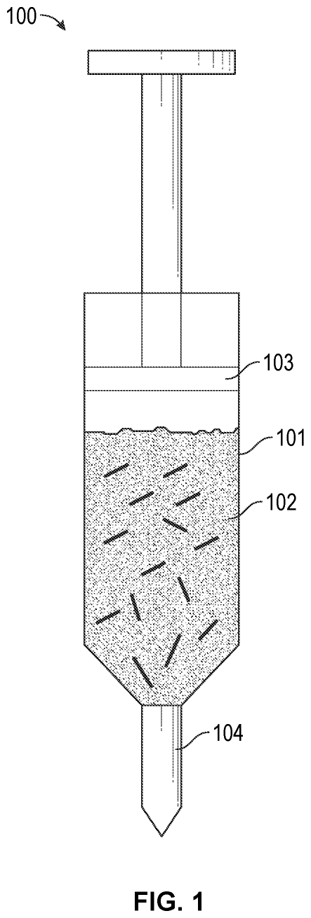

An embodiment of a container is depicted at FIG. 1. The container 100 of FIG. 1 includes a reservoir 101 in which a CUF formulation 102 is disposed. The container also includes a plunger 103 and a nozzle 104. Although not depicted at FIG. 1, the containers provided herein may include other components, such as a feed tube and/or a fluid chamber, wherein the feed tube and/or the fluid chamber may be in fluid communication with a reservoir, such as a syringe and a nozzle.

### Methods

Also provided herein are methods of applying a CUF material. The methods may include providing a CUF formulation as provided herein; providing an apparatus that may include a substrate, a die, and a plurality of supporting structures arranged between and in contact with the substrate and the die; disposing a first portion of a CUF formulation on the apparatus at a location effective to permit a capillary force to initiate a capillary flow of the first portion of the CUF formulation between the substrate and the die; and curing the matrix material precursor of the first portion of the CUF formulation to form a cured CUF material. The disposing step of the methods may be repeated one or more times by applying, for example, a second portion, a third portion, a fourth portion, etc. of the CUF formulations. The second portion, third portion, fourth portion, etc. may be disposed at the same location as the first portion, or a different location.

The substrate and the die may be arranged substantially parallel to each other. The plurality of supporting structures arranged between and in contact with the substrate and the die may include solder bumps. The solder bumps may be distributed substantially evenly in a gap space between a substrate and a die. The substrate and die may be formed of any known materials. For example, the die may be formed at least in part of silicon.

The capillary force that may initiate a capillary flow of a CUF formulation may be effective to at least partially align a plurality of carbon nanotubes, such as a plurality of surface functionalized carbon nanotubes. A plurality of carbon nanotubes is “at least partially aligned” when the carbon nanotubes are not randomly oriented. A plurality of carbon nanotubes is “aligned” when the longitudinal axes of at least 90 wt % of the carbon nanotubes are arranged at an angle within ±15° of a theoretical line indicating the alignment direction.

The curing of the matrix material may be achieved by any known technique, including, but not limited to, heating. In some embodiments, the cured CUF material may have a Young's modulus that is at least 5%, at least 10%, at least 20%, at least 30%, at least 40%, or at least 50% greater than a Young's modulus of a comparative cured CUF material that lacks a plurality of surface functionalized carbon nanotubes. In some embodiments, the cured CUF material may have a thermal conductivity that is at least 5%, at least 10%, at least 20%, at least 30%, at least 40%, or at least 50% greater than a thermal conductivity of a comparative cured CUF material that lacks a plurality of surface functionalized carbon nanotubes. A “comparative cured CUF material” is a CUF material prepared in an identical manner as those provided herein, but for the inclusion of a plurality of carbon nanotubes.

Not wishing to be bound any particular theory, it is believed that a plurality of carbon nanotubes, such as a plurality of surface functionalized carbon nanotubes, may improve fracture toughness, reduce crack propagation, and/or reduce or prevent delamination, likely due to the carbon nanotubes' crack bridging properties and/or enhanced adhesion to a matrix material.

The disposing of a CUF formulation on an apparatus may be achieved by any known technique. For example, the disposing of a first portion (or second, third, fourth portion, etc.) of a CUF formulation on an apparatus may include dispensing the first portion (or second, third, fourth portion, etc.) of the CUF formulation with a nozzle, such as a nozzle of the containers provided herein. The nozzle may have a diameter effective to impart a shearing force that at least partially aligns the carbon nanotubes, such as the surface functionalized carbon nanotubes. The disposing of the first portion (or second, third, fourth portion, etc.) of the CUF formulation may include jet dispensing the first portion (or second, third, fourth portion, etc.) of the CUF formulation.

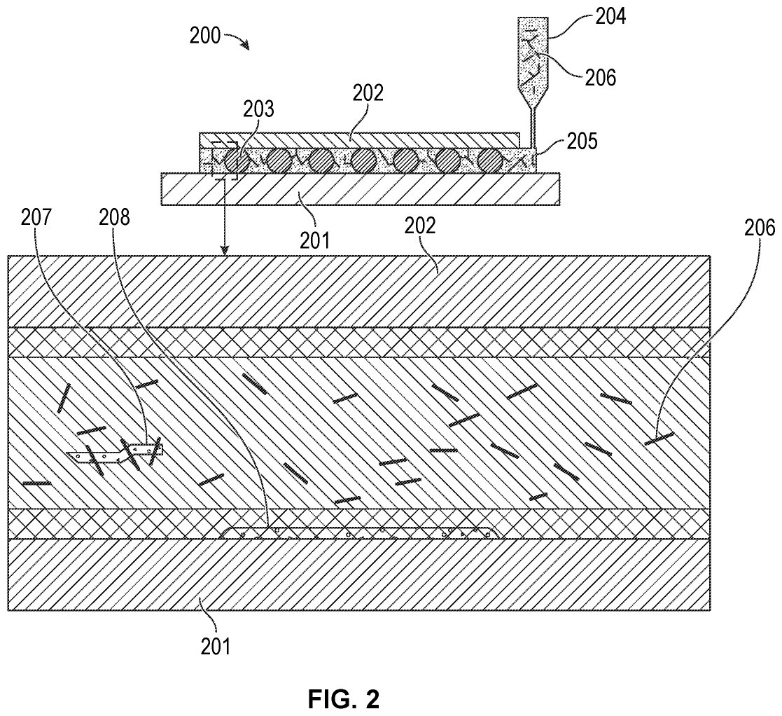

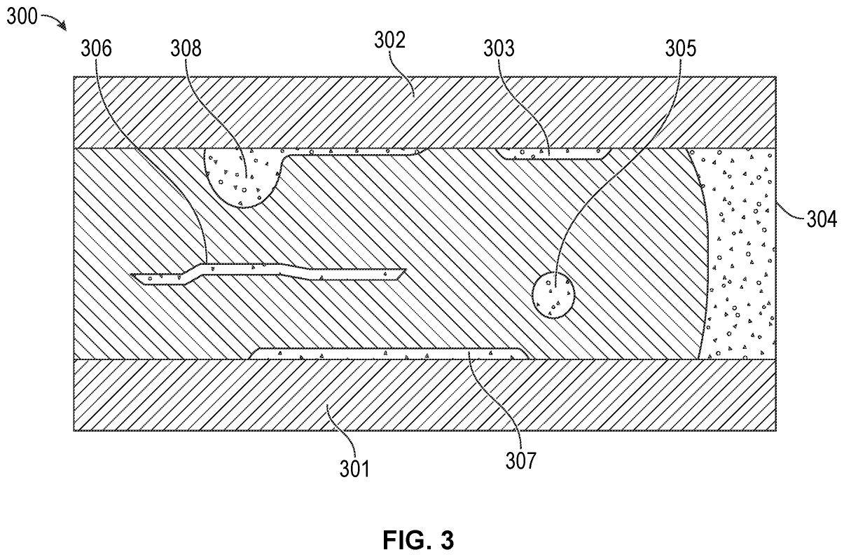

A schematic of an embodiment provided herein is depicted at FIG. 2. The apparatus 200 of FIG. 2 includes a substrate 201, a die 202, and a plurality of solder bumps 203 arranged between the substrate 201 and the die 202. A dispenser 204 is used in FIG. 2 to dispose a CUF formulation 205 onto the substrate 201 at a location adjacent the die 202. The CUF formulation 205 includes a plurality of carbon nanotubes 206. Due to the presence of the plurality of carbon nanotubes 206, the cured CUF material may exhibit reduced crack propagation 207 and enhanced adhesion 208 to the substrate 201. A comparative CUF material 300 prepared in the same manner as FIG. 2, but without carbon nanotubes, is depicted at FIG. 3. FIG. 3 depicts a CUF material 300 arranged between a substrate 301 and die 302, and the CUF material 300 has a number of undesirable features, one or more of which would likely be present, due to the absence of carbon nanotubes. The CUF material 300, for example, may include delamination 303 along the die 302, a large void 304, an isolated void 305, a crack 306 in the die-attach material, delamination 307 along the substrate 301, and a void 308 at the die interface that may expand as delamination.

The methods provided herein may also include subjecting the CUF formulation to a magnetic field effective to at least partially align the plurality of carbon nanotubes before and/or during the disposing of the first portion of the CUF formulation on the apparatus.

The phrases “C₁-C₁₀ hydrocarbyl”, and the like, as used herein, generally refer to unsubstituted or substituted aliphatic, unsubstituted or substituted aryl, or unsubstituted or substituted arylalkyl groups containing 1 to 10 carbon atoms. Examples of aliphatic groups, in each instance, include, but are not limited to, an alkyl group, a cycloalkyl group, an alkenyl group, a cycloalkenyl group, an alkynyl group, an alkadienyl group, a cyclic group, and the like, and includes all substituted, unsubstituted, branched, and linear analogs or derivatives thereof, in each instance having 1 to about 10 carbon atoms. Examples of alkyl groups include, but are not limited to, methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, and decyl. Cycloalkyl moieties may be monocyclic or multicyclic, and examples include cyclopropyl, cyclobutyl, cyclopentyl, cyclohexyl, and adamantyl. Additional examples of alkyl moieties have linear, branched and/or cyclic portions (e.g., 1-ethyl-4-methyl-cyclohexyl). Representative alkenyl moieties include vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-decenyl, 2-decenyl and 3-decenyl. Representative alkynyl moieties include acetylenyl, propynyl, 1-butynyl, 2-butynyl, 1-pentynyl, 2-pentynyl, 3-methyl-1-butynyl, 4-pentynyl, 1-hexynyl, 2-hexynyl, 5-hexynyl, 1-heptynyl, 2-heptynyl, 6-heptynyl, 1-octynyl, 2-octynyl, 7-octynyl, 1-nonynyl, 2-nonynyl, 8-nonynyl, 1-decynyl, 2-decynyl, and 9-decynyl. Examples of aryl or arylalkyl moieties include, but are not limited to, anthracenyl, azulenyl, biphenyl, fluorenyl, indan, indenyl, naphthyl, phenanthrenyl, phenyl, 1,2,3,4-tetrahydro-naphthalene, tolyl, xylyl, mesityl, benzyl, and the like, including any heteroatom substituted derivative thereof.

Unless otherwise indicated, the term “substituted”, when used to describe a chemical structure or moiety, refers to a derivative of that structure or moiety wherein (i) a multi-valent non-carbon atom (e.g., oxygen, nitrogen, sulfur, phosphorus, etc.) is bonded to one or more carbon atoms of the chemical structure or moiety (e.g., a “substituted” C₄ hydrocarbyl may include, but is not limited to, diethyl ether moiety, a methyl propionate moiety, an N,N-dimethylacetamide moiety, a butoxy moiety, etc., and a “substituted” aryl C₁₂ hydrocarbyl may include, but is not limited to, an oxydibenzene moiety, a benzophenone moiety, etc.) or (ii) one or more of its hydrogen atoms (e.g., chlorobenzene may be characterized generally as an aryl C₆ hydrocarbyl “substituted” with a chlorine atom) is substituted with a chemical moiety or functional group such as alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH-alkyl- or -alkylNHC(O)alkyl), tertiary amine (such as alkylamino, arylamino, arylalkylamino), aryl, aryloxy, azo, carbamoyl (—NHC(O)O-alkyl- or —OC(O)NH-alkyl), carbamyl (e.g., CONH₂, as well as CONH-alkyl, CONH-aryl, and CONH-arylalkyl), carboxyl, carboxylic acid, cyano, ester, ether (e.g., methoxy, ethoxy), halo, haloalkyl (e.g., —CCl₃, —CF₃, —C(CF₃)₃), heteroalkyl, isocyanate, isothiocyanate, nitrile, nitro, oxo, phosphodiester, sulfide, sulfonamido (e.g., SO₂NH₂), sulfone, sulfonyl (including alkylsulfonyl, arylsulfonyl and arylalkylsulfonyl), sulfoxide, thiol (e.g., sulfhydryl, thioether) or urea (—NHCONH-alkyl-).

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When devices, compositions, or methods are claimed or described in terms of “comprising” various steps or components, the devices, systems, or methods can also “consist essentially of” or “consist of” the various steps or components, unless stated otherwise.

The terms “a,” “an,” and “the” are intended to include plural alternatives, e.g., at least one. For instance, the disclosure of “a filler”, “a formulation”, and the like, is meant to encompass one, or mixtures or combinations of more than one filler, formulation, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, that the plurality of surface functionalized carbon nanotubes has an average length of about 25 nm to 50 nm. This range should be interpreted as encompassing about 25 nm and about 50 nm, and about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 39 nm, about 40 nm, about 41 nm, about 42 nm, about 43 nm, about 44 nm, about 45 nm, about 46 nm, about 47 nm, about 48 nm, and about 49 nm, including any ranges and sub-ranges between any of these values.

As used herein, the term “about” means plus or minus 10% of the numerical value of the number with which it is being used.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

The following examples pertain to further embodiments.

Example 1 may include a CUF formulation that includes a matrix material precursor; and a filler dispersed in the matrix material precursor, wherein the filler may include a plurality of carbon nanotubes, such as surface functionalized carbon nanotubes.

Example 2 may include the CUF formulation of example 1 and/or any other example disclosed herein, wherein the filler may include silica particles.

Example 3 may include the CUF formulation of example 1 and/or any other example disclosed herein, wherein the plurality of carbon nanotubes, such as the plurality of surface functionalized carbon nanotubes, may be present in the formulation at a concentration of about 0.1% to about 10%, 0.1% to about 8%, 0.1% to about 6%, 0.1% to about 4%, 0.1% to about 2%, about 0.5% to about 1.5%, less than 5%, less than 4%, less than 3%, less than 2%, or less than 1%, by weight, based on the weight of the formulation.

Example 4 may include the CUF formulation of example 1 and/or any other example disclosed herein, wherein the silica particles may be present in the formulation at a concentration of about 0.1% to about 10%, 0.1% to about 8%, 0.1% to about 6%, 0.1% to about 4%, 0.1% to about 2%, about 0.5% to about 1.5%, less than 5%, less than 4%, less than 3%, less than 2%, or less than 1%, by weight, based on the weight of the formulation.

Example 5 may include the CUF formulation of example 1 and/or any other example disclosed herein, wherein the surface functionalized carbon nanotubes may include carbon nanotubes substituted with a moiety that may include a nucleophilic group or an electrophilic group.

Example 6 may include the CUF formulation of example 5 and/or any other example disclosed herein, wherein the nucleophilic group may include an amine, and, therefore, the plurality of surface functionalized carbon nanotubes may include amine functionalized carbon nanotubes.

Example 7 may include the CUF formulation of example 6 and/or any other example disclosed herein, wherein the amine may be a primary amine, a secondary amine, or a tertiary amine.

Example 8 may include the CUF formulation of example 5 and/or any other example disclosed herein, wherein the electrophilic group may include an anhydride, an alkyl halide, or a peracid.

Example 9 may include the CUF formulation of example 1 and/or any other example disclosed herein, wherein the plurality of surface functionalized carbon nanotubes may have an average length of about 5 nm to 50 nm, about 10 nm to about 50 nm, about 20 nm to about 50 nm, about 25 nm to about 50 nm, about 30 nm to about 50 nm, about 35 nm to about 50 nm, or about 40 nm to about 50 nm.

Example 10 may include the CUF formulation of example 1 and/or any other example disclosed herein, wherein the plurality of surface functionalized carbon nanotubes may have an average aspect ratio of about 100:1 to about 100,000:1, about 1,000:1 to about 100,000:1, about 10,000:1 to about 100,000:1, about 20,000:1 to about 100,000:1, about 30,000:1 to about 100,000:1, about 40,000:1 to about 100,000:1, about 50,000:1 to about 100,000:1, about 100:1 to about 50,000:1, about 100:1 to about 40,000:1, about 100:1 to about 30,000:1, about 100:1 to about 20,000:1, about 100:1 to about 10,000:1, about 100:1 to about 1,000:1, or about 100:1 to about 500:1.

Example 11 may include the CUF formulation of example 1 and/or any other example disclosed herein, wherein the plurality of surface functionalized carbon nanotubes may include multi-walled surface functionalized carbon nanotube, single-walled surface functionalized carbon nanotubes, or a combination thereof.

Example 12 may include the CUF formulation of example 1 and/or any other example disclosed herein, wherein the matrix material precursor may include an epoxy resin precursor.

Example 13 may include a container that includes a reservoir in which the formulation of example 1 and/or any other example may be disposed.

Example 14 may include the container of example 13 and/or any other example disclosed herein wherein the reservoir may be a syringe.

Example 15 may include the container of example 13 and/or any other example disclosed herein, wherein the container also may include a dispensing nozzle.

Example 16 may include a method of applying a CUF material, and the method may include providing the CUF formulation of example 1 and/or any other example disclosed herein; providing an apparatus that may include a substrate, a die, and a plurality of supporting structures arranged between and in contact with the substrate and the die, wherein the substrate and the die may be arranged substantially parallel to each other; disposing a first portion of the CUF formulation on the apparatus at a location effective to permit a capillary force to initiate a capillary flow of the first portion of the CUF formulation between the substrate and the die; and curing the matrix material precursor of the first portion of the CUF formulation to form a cured CUF material.

Example 17 may include the method of example 16 and/or any other example disclosed herein, wherein the capillary force may be effective to at least partially align the plurality of surface functionalized carbon nanotubes.

Example 18 may include the method of example 16 and/or any other example disclosed herein, wherein the method also may include disposing a second portion of the CUF formulation on the apparatus at the location.

Example 19 may include the method of example 18 and/or any other example disclosed herein, wherein the method also may include disposing a third portion of the CUF formulation on the apparatus at the location.

Example 20 may include the method of example 19 and/or any other example disclosed herein, wherein the method also may include disposing a fourth portion of the CUF formulation on the apparatus at the location.

Example 21 may include the method of example 16 and/or any other example disclosed herein, wherein the cured CUF material may have a Young's modulus that is at least 5%, at least 10%, at least 20%, at least 30%, at least 40%, or at least 50% greater than a Young's modulus of a comparative cured CUF material that lacks the plurality of surface functionalized carbon nanotubes.

Example 22 may include the method of example 16 and/or any other example disclosed herein, wherein the cured CUF material may have a thermal conductivity that is at least 5%, at least 10%, at least 20%, at least 30%, at least 40%, or at least 50% greater than a thermal conductivity of a comparative cured CUF material that lacks the plurality of surface functionalized carbon nanotubes.

Example 23 may include the method of example 16 and/or any other example disclosed herein, wherein the disposing of the first portion (or second, third, fourth portion, etc.) of the CUF formulation may include dispensing the first portion (or second, third, fourth portion, etc.) of the CUF formulation with a nozzle.

Example 24 may include the method of example 23 and/or any other example disclosed herein, wherein the nozzle may have a diameter effective to impart a shearing force that at least partially aligns the surface functionalized carbon nanotubes.

Example 25 may include the method of example 16 and/or any other example provided herein, wherein the disposing of the first portion (or second, third, fourth portion, etc.) of the CUF formulation may include jet dispensing the first portion (or second, third, fourth portion, etc.) of the CUF formulation.

Example 26 may include the method of example 16 and/or any other example provided herein, wherein the method may also include subjecting the CUF formulation to a magnetic field effective to at least partially align the plurality of carbon nanotubes before and/or during the disposing of the first portion of the CUF formulation on the apparatus.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A capillary underfill (CUF) formulation comprising:
a matrix material precursor; and
a filler dispersed in the matrix material precursor, the filler comprising silica particles and a plurality of surface functionalized carbon nanotubes;
wherein the plurality of surface functionalized carbon nanotubes is present in the CUF formulation at a concentration of about 0.1% to about 10%, by weight, based on the weight of the CUF formulation; and
wherein the silica particles are present in the CUF formulation at a concentration of about 0.1% to about 10%, by weight, based on the weight of the CUF formulation.

2. The CUF formulation of claim 1, wherein the surface functionalized carbon nanotubes comprise carbon nanotubes substituted with a moiety that includes a nucleophilic group or an electrophilic group.

3. The CUF formulation of claim 1, wherein the plurality of surface functionalized carbon nanotubes comprises amine functionalized carbon nanotubes substituted with a moiety of the following formula: 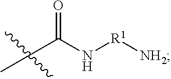
wherein R¹ is a divalent C₁-C₁₀ hydrocarbyl.

4. The CUF formulation of claim 1, wherein the plurality of surface functionalized carbon nanotubes is present in the formulation at a concentration of about 0.5% to about 1.5%, by weight, based on the weight of the CUF formulation.

5. The CUF formulation of claim 1, wherein the plurality of surface functionalized carbon nanotubes has an average length of about 5 nm to 50 nm.

6. The CUF formulation of claim 1, wherein the plurality of surface functionalized carbon nanotubes has an average aspect ratio of about 100:1 to about 100,000:1.

7. The CUF formulation of claim 1, wherein the plurality of surface functionalized carbon nanotubes has an average aspect ratio of about 100:1 to about 50,000:1.

8. The CUF formulation of claim 1, wherein the plurality of surface functionalized carbon nanotubes comprises multi-walled surface functionalized carbon nanotubes.

9. The CUF formulation of claim 1, wherein the plurality of surface functionalized carbon nanotubes comprises single-walled surface functionalized carbon nanotubes.

10. The CUF formulation of claim 1, wherein the matrix material precursor is an epoxy resin precursor.

11. A container comprising:
a reservoir in which the CUF formulation of claim 1 is disposed.

12. The container of claim 11, wherein the container is a syringe, and the container further comprises a nozzle for dispensing the CUF formulation.

13. A method of applying a CUF material, the method comprising:
providing the CUF formulation of claim 1;
providing an apparatus comprising a substrate, a die, and a plurality of supporting structures arranged between and in contact with the substrate and the die, wherein the substrate and the die are arranged substantially parallel to each other;
disposing a first portion of the CUF formulation on the apparatus at a location effective to permit a capillary force to initiate a capillary flow of the first portion of the CUF formulation between the substrate and the die; and
curing the matrix material precursor of the first portion of the CUF formulation to form a cured CUF material.

14. The method of claim 13, wherein the capillary force is effective to at least partially align the plurality of surface functionalized carbon nanotubes.

15. The method of claim 13, further comprising disposing a second portion of the CUF formulation on the apparatus at the location.

16. The method of claim 13, wherein the cured CUF material has—
(i) a Young's modulus that is at least 10% greater than a Young's modulus of a comparative cured CUF material that lacks the plurality of surface functionalized carbon nanotubes,
(ii) a thermal conductivity that is at least 10% greater than a thermal conductivity of a comparative cured CUF material that lacks the plurality of surface functionalized carbon nanotubes, or
(iii) a combination thereof.

17. The method of claim 13, wherein the disposing of the first portion of the CUF formulation comprises dispensing the first portion of the CUF formulation with a nozzle.

18. The method of claim 17, wherein the nozzle has a diameter effective to impart a shearing force that at least partially aligns the plurality of surface functionalized carbon nanotubes.

19. The method of claim 13, wherein the disposing of the first portion of the CUF formulation comprises jet dispensing the first portion of the CUF formulation.

20. The method of claim 13, further comprising subjecting the CUF formulation to a magnetic field effective to at least partially align the plurality of carbon nanotubes before, during, or before and during the disposing of the first portion of the CUF formulation on the apparatus.
